(19) United States
(12) Patent Application Publication
(10) Pub. No.: US 2026/0280837 A1
(43) Pub. Date: Sep. 17, 2026

(54) DYNAMIC PERFORMANCE CONTROL USING HALF DUPLEX ARRAYS

(71) Applicant: Hughes Network Systems, LLC, Germantown, MD (US)

(72) Inventors: Channasandra Ravishankar, Clarksburg, MD (US); Xiaoling Huang, Boyds, MD (US)

(21) Appl. No.: 19/340,450

(22) Filed: Sep. 25, 2025

Related U.S. Application Data
(60) Provisional application No. 63/770,794, filed on Mar. 12, 2025.

(51) Int. Cl. H04L 5/16; H04B 7/185; H04B 7/19

(52) U.S. Cl. CPC H04L 5/16; H04B 7/1851; H04B 7/19

(57) ABSTRACT

A communication terminal is disclosed that uses multiple half-duplex (HDX) apertures to provide enhanced performance, flexibility, and reliability. This system can improve on the performance of a full-duplex (FDX) terminal by dynamically allocating time for transmitting (TX) and receiving (RX) across the various HDX apertures according to demand. Such a configuration can improve overall performance, such as by allowing for significantly more data throughput compared to a traditional FDX terminal with dedicated apertures. Furthermore, the use of multiple HDX apertures can create a more robust system; if one aperture fails, the remaining apertures can continue to operate, preventing a total loss of communication and merely reducing total bandwidth.

### CROSS REFERENCE TO RELATED APPLICATIONS

This application claims priority to U.S. Provisional Patent Application No. 63/770,794, filed on Mar. 12, 2025, the disclosure of which is incorporated by reference in its entirety for all purposes.

### BACKGROUND

Half-duplex and (HDX) and full-duplex (FDX) user terminals are used to communicate with satellites. An HDX terminal can only receive or transmit signals at a given time. In contrast, signals from an FDX terminal can both be transmitted and received at the same time. An FDX terminal conventionally includes an antenna that includes a transmit (TX) aperture and a receive (RX) aperture. These separate apertures, along with corresponding front-end hardware, allow for transmission and reception of RF signals simultaneously. In contrast, an HDX terminal includes a single aperture which is used for both transmission and reception, albeit at different times. One drawback of FDX terminals is that because of the increased size of the antenna (two apertures) and additional hardware, FDX terminals are more expensive to manufacture.

### SUMMARY

In some embodiments, a user terminal system can be provided. The system may comprise a first half duplex (HDX) aperture system that includes a first aperture. The system can also comprise a second half duplex aperture system that includes a second aperture distinct from the first aperture. The system can include one or more modems in communication with the first half duplex aperture system and the second half duplex aperture system. The system may also include an arbitrator in communication with the one or more modems. A first amount of time can be allocated to data transmission for the first half duplex aperture system, and a second amount of time can be allocated to data transmission for the second half duplex aperture system.

Each of the following features can be separately incorporated as part of the system or can be incorporated together with one or more other following features. The first aperture and the second aperture may be distinct portions of one antenna array. The first half duplex aperture system can communicate with a different satellite beam than the second half duplex aperture system. The first half duplex aperture system may be configured to communicate with a first satellite while the second half duplex aperture system communicates with a second satellite. The first satellite can be in low earth orbit, and the second satellite can be in geosynchronous orbit. The first amount of time may be different than the second amount of time. The user terminal system can be configured to be set to a full duplex emulation mode. In this mode, the first half duplex aperture system may be used exclusively to transmit data, and the second half duplex aperture system may be used exclusively to receive data. The arbitrator can be configured to communicate with an indoor unit. The arbitrator may also be configured to route communications between the indoor unit, a first modem of the one or more modems, and a second modem of the one or more modems. The user terminal system may be configured to modify the first amount of time allocated to data transmission for the first half duplex aperture system in response to the second half duplex aperture system becoming unavailable. The system can further comprise a satellite gateway system and a satellite configured to communicate with the satellite gateway system. The one or more modems may communicate with the Internet via the satellite gateway system.

In some embodiments, a method for using multiple half duplex (HDX) aperture arrays is provided. The method may include providing a user terminal system that includes a first HDX aperture system and a second HDX aperture system. The method can involve determining, by the user terminal system, a first timing for transmitting and receiving signals for the first HDX aperture system. The method can also involve determining, by the user terminal system, a second timing for transmitting and receiving signals for the second HDX aperture system. Data may be transmitted to a satellite gateway system via the first HDX aperture system, the second HDX aperture system, or both, in accordance with the determined first and second timings. Data may also be received from the satellite gateway system via the first HDX aperture system, the second HDX aperture system, or both, in accordance with the determined first timing and the determined second timing.

Each of the following features can be separately incorporated as part of the method or can be incorporated together with one or more other following features. The first HDX aperture system can comprise a first aperture and the second HDX aperture system can comprise a second aperture. The first aperture and the second aperture may be distinct portions of one antenna array. The method may further comprise communicating, by the first HDX aperture system, with a different satellite beam than the second HDX aperture system. The method can also include communicating, by the first HDX aperture system, with a first satellite while the second HDX aperture system communicates with a second satellite. The first satellite may be in low earth orbit, and the second satellite may be in geosynchronous orbit. The first timing can allocate a different amount of time to data transmission than the second timing. The method may further comprise operating in a full duplex emulation mode. In this mode, determining the first timing can comprise allocating all available time for the first HDX aperture system to transmitting data. Determining the second timing can comprise allocating all available time for the second HDX aperture system to receiving data. An arbitrator may perform the determination of the first timing and the second timing. The method can further comprise detecting that the second HDX aperture system has become unavailable and, in response, modifying the first timing for the first HDX aperture system. The transmission of data to, and reception of data from, the satellite gateway system may occur via a satellite. This satellite can be in communication with a satellite gateway antenna coupled to the satellite gateway system, thereby enabling communication with the Internet.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a user terminal that includes multiple HDX aperture arrays.

FIG. 2A illustrates an embodiment of a timing diagram for a HDX aperture array transmitting and receiving signals.

FIG. 2B illustrates another embodiment of a timing diagram for a HDX aperture array transmitting and receiving signals.

FIG. 3 illustrates an embodiment of a satellite communication system that uses multi-HDX arrays.

FIG. 4 illustrates an embodiment of a signal strength diagram in which a user terminal that includes a multi-HDX arrays is located between spot beams.

FIG. 5 illustrates an embodiment of a system that includes multiple HDX aperture arrays operating in a fully duplex emulation mode.

FIG. 6 illustrates an embodiment of a method for using a user terminal that includes multiple HDX aperture arrays.

### DETAILED DESCRIPTION

Rather than implementing a FDX terminal that uses a dedicated receive aperture and corresponding hardware and a dedicated transmit aperture and corresponding hardware, embodiments detailed herein can use multiple HDX apertures to improve overall performance, be more robust to failures, and, if desired, emulate an FDX terminal.

Using multiple HDX apertures can provide improved overall performance compared to an FDX terminal. An FDX terminal includes dedicated transmit and dedicated receive apertures. However, an HDX terminal is configured to both transmit and receive at different times. Thus, when multiple HDX apertures are present, each HDX aperture can be provided more time to transmit or receive, depending on the use case. For example, where a large amount of data is being downloaded to by the HDX apertures, 80% of time may be dedicated to RX while 10% of time is dedicated to TX (with 10% of time allocated to mode switching). By each HDX aperture spending 80% of its time on RX, significantly more data can be received in total than a single aperture of an FDX terminal being used to receive 100% of the time.

Using multiple HDX apertures provides improved robustness in the face of aperture failures. For example, in an FDX terminal, if the TX aperture fails, the entire FDX terminal stops functioning since the entire ability of the FDX terminal to transmit is unavailable. However, in a multiple HDX aperture arrangement, if one HDX aperture fails, another HDX aperture can continue functioning, such as by alternating between transmitting and receiving. Thus while total communication bandwidth is decreased, no total failure of the terminal occurs. Such an arrangement also provides significant advantages over manufacturing separate HDX terminals and FDX terminals for different user types (e.g., a low bandwidth consumers, high bandwidth consumers).

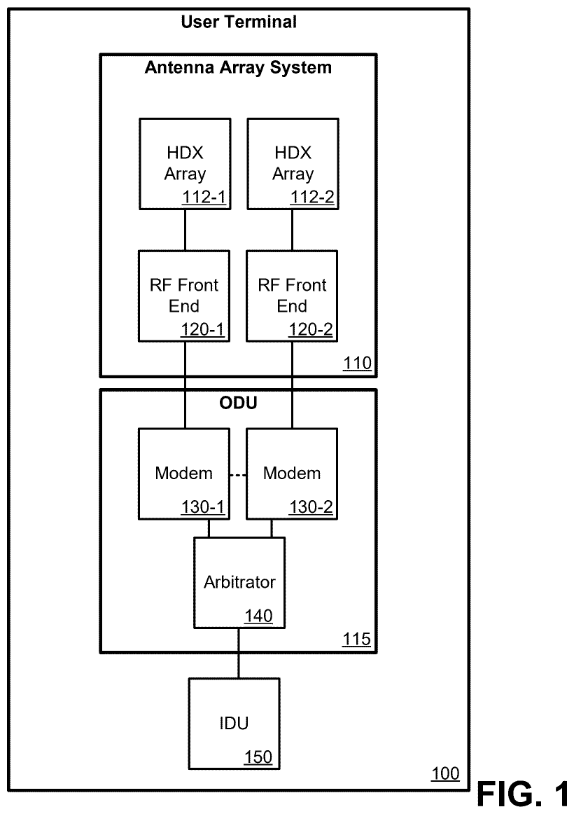

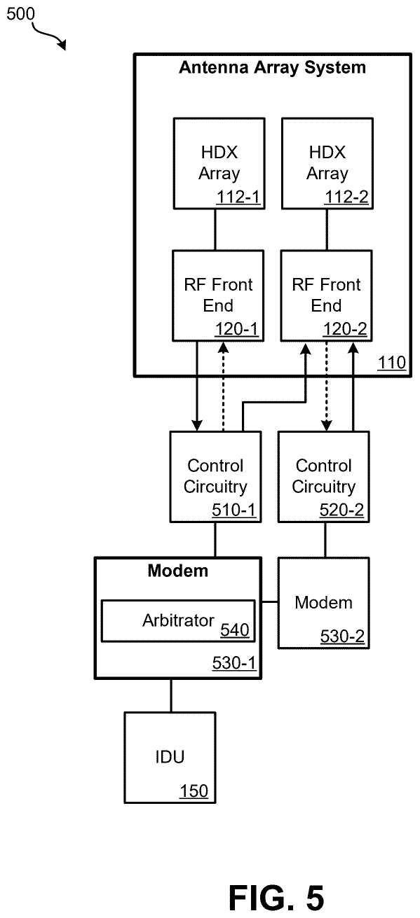

Further detail regarding these and additional embodiments is provided in relation to the figures. FIG. 1 illustrates an embodiment of a user terminal 100 that includes multiple HDX aperture arrays. User terminal 100 can include indoor unit (IDU) 150 in communication with an arbitrator 140. IDU 150 may be a component of the user terminal 100 that is coupled to outdoor unit (ODU) 115, which is described in more detail with respect to FIG. 5. User terminal 100 may be an end-point (also known as an edge device) in a communication network that enables a user (or machines) to access network services to transmit (TX), and receive (RX), data. In this manner, IDU 150 may include telecommunication components inside of a building (e.g., a house, corporation, etc.) that interface with external equipment (e.g., ODU 115) for power and/or external communication. IDU 150 may include baseband processing components, network interfacing components, signal modulation/demodulation components (e.g., modems 130), and various suitable components designed to facilitate TX/RX operations in conjunction with the arbitrator 140, modems 130, and antenna array system 110.

The antenna array system 110 includes hardware components. For example, the antenna array system 110 can include a first HDX array 112-1 and a second HDX array 112-2. As mentioned above, HDX arrays 112 are able to TX and RX, but not at the same time since at least some of the same hardware is used for both transmitting and receiving. For example, first HDX array 112-1 and second HDX array 112-2 include a first aperture and a second aperture, respectively. The first HDX array 112-1 and the first aperture may form at least part of a first HDX aperture system while second HDX array 112-2 and the second aperture may form at least part of a second HDX aperture system. In some examples, the first aperture and the second aperture may be distinct portions of one antenna array.

Throughout this disclosure, the term “aperture” is used to refer to the physical region or surface of an antenna or antenna array through which electromagnetic energy is transmitted or received, defining an area for coupling signals between the antenna and free space. A size, shape, and orientation of the aperture may be suitably selected to selectively influence antenna parameters (e.g., gain, directivity, and beamwidth). As used herein, HDX arrays 112 may alternate between TX and RX modes and the respective apertures may be used for both functions in sequence or may include separate apertures for each mode to optimize performance and/or provide spatial isolation. Multiple apertures may support different frequency bands, distinct coverage sectors, and/or redundancy for reliability.

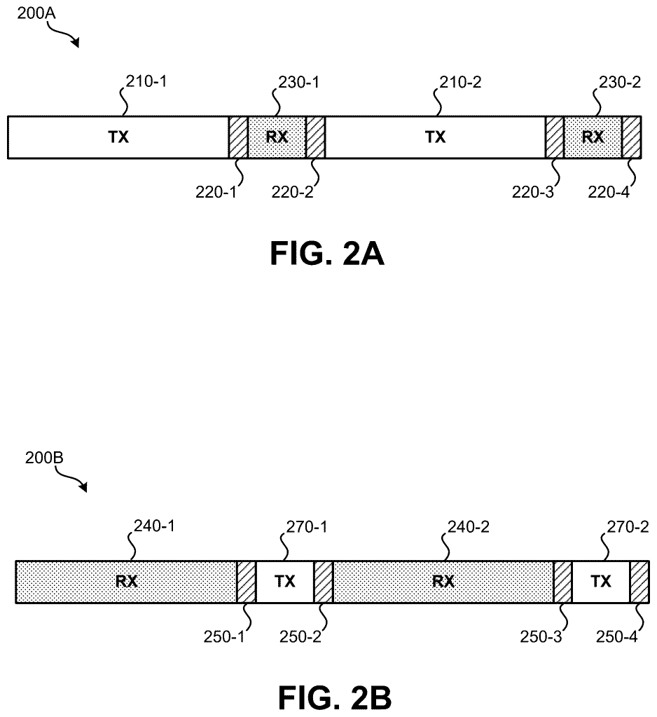

In some examples, each HDX aperture system may be a phased array with electronically adjustable signal phases to enable directional beam steering for TX/RX modes. For example, an aperture of an HDX aperture system implemented as a phased array may be an area of elements that serve as an interface for radiating or capturing RF energy. For example, half-HDX aperture systems implementing phased arrays include, without limitation, planar microstrip patch arrays where multiple patch elements are arranged in a grid and electronically controlled to steer the beam direction during either TX/RX modes that alternate based on communication protocol timing (described with respect to FIG. 2). Another example is a conformal array of dipole antennas mounted on the surface of a building or vehicle that provide adaptive coverage over a wide area by dynamically adjusting a phase of each element to direct energy toward intended sources (e.g., satellites). In sectorized cellular base stations, HDX aperture systems implementing phased arrays may include separate linear or planar arrays for each sector, with each array sequentially handling TX/RX functions to optimize coverage and minimize interference. Additionally, or alternatively, HDX aperture systems implementing phased arrays can be configured for multi-band operation, where distinct sets of array elements form separate apertures, each optimized for a particular frequency band.

The description of apertures in connection with HDX aperture system is provided by way of example and is not intended to be limiting. Any suitable aperture configuration may be utilized, including but not limited to planar surfaces, conformal arrangements, linear arrays, microstrip patches, dipole elements, slot antennas, or combinations thereof. The choice of aperture type, size, shape, and spatial arrangement may be suitably selected according to operation needs, operating frequencies, coverage objectives, and/or performance criteria, and may encompass single or multiple apertures as appropriate for the intended application. Accordingly, references to specific aperture embodiments should be understood to encompass all suitable forms and variations of HDX apertures capable of supporting TX/RX operations.

The HDX arrays 112 are coupled to respective radio frequency (RF) front ends 120. The RF front ends 120 interface with TX/RX RF signals received by respective apertures. The RF front ends 120 may include components such as, but not limited to, filters, amplifiers (e.g., low noise amplifiers, LNAs), and/or mixers to condition, amplify, and/or convert RF signals for further processing by modems 130 and/or arbitrator 140. The arbitrator 140 may facilitate communication with the IDU 150 and route communications between the IDU 150, a first modem 130-1 and a second modem 130-2. In various embodiments, the arbitrator 140 is incorporated as firmware, software, and/or hardware with the modems 130.

Arbitrator 140 may manage an allocation and timing of TX and RX operations, providing access to shared transmission resources and preventing signal conflicts. The modems 130, which perform signal modulation, demodulation, and protocol conversion functions, interface directly with arbitrator 140 to coordinate operational states. Communication between arbitrator 140 and the modems 130 may occur via dedicated control signaling, command interfaces, or internal bus protocols, whereby the arbitrator 140 issues instructions indicating whether to enter TX or RX mode, manages timing for switching between these modes, and monitors modem 130 status to facilitate efficient data transfer. For example, the arbitrator 140 may send a control signal to activate a TX mode of respective modems 130 during a scheduled transmission interval, then subsequently instruct respective modems 130 to switch to RX mode for inbound data. Using the first HDX aperture system and the second HDX aperture system in this manner enables emulation of FDX. The allocation of timing between HDX array 112-1 and HDX array 112-2 may be determined based on parameters such as traffic demand, quality of service requirements, channel conditions, network topology (e.g., satellite location), or system protocols, and may be fixed or adaptively adjusted in real time. By assigning separate transmission periods to each HDX array 112-1 and HDX array 112-2, the communication system can optimize and/or increase bandwidth utilization, minimize interference, support load balancing, or facilitate redundant (in case of array failure) or multi-link operation.

Arbitrator 140 can further assign data received from IDU 150 to a specific modem of modems 130 for transmission. For example, if modem 130-1 handles 80% of data transmission, arbitrator 140 can direct approximately 80% of data to be transmitted to modem 130-1. While arbitrator 140 is shown as separate from modems 130, in some embodiments arbitrator 140 can be incorporated as part of a modem.

FIG. 2A illustrates an embodiment of a timing diagram 200A for a HDX aperture array transmitting and receiving signals. Timing diagram 200A illustrates an embodiment of switching between TX mode 210 and RX mode 230 including guard intervals 220 where an HDX aperture system switches between the modes. In an example, suppose that an application needs to be in TX mode 210 80% of the time and RX mode 230 10% of the time. This could be an example in which user terminal 100 is transmitting a video stream and receiving only acknowledgements (ACK) from a network (e.g., Internet server). In some implementations of HDX described herein, there is a non-zero switching time (e.g., guard intervals 220) between TX circuit and RX circuit. For example, guard intervals 220 may have allocated 10% of the time for switching; hence a total of TX+RX=90% in this example.

The timing for the TX mode and the RX mode may be based at least in part on bandwidth limitations, traffic needs, and/or control logic, and can range from fixed intervals (e.g., one millisecond (ms) transmit periods followed by one ms receive periods) to dynamically adjustable slots based on real-time link conditions). For example, in a time-division HDX implementation, the user terminal may alternate between transmitting and receiving every 5 ms, ensuring that only one mode is active during any given interval. The duration of each transmit and receive slot may be optimized for throughput, latency, satellite availability, and/or synchronization with external network timing, and can be configured to support a variety of communication standards and application scenarios.

FIG. 2B illustrates an embodiment of a timing diagram 200B for a HDX aperture array transmitting and receiving signals. The timing diagram 200B illustrates another embodiment of switching between RX mode 240 and TX mode 270 including guard intervals 250 where an HDX aperture system switches between the modes. In an example, suppose that an application needs to be in RX mode 240 80% of the time and TX mode 270 10% of the time. This example uses a 100 ms communication cycle for video streaming to a smart TV or mobile device, by way of a user terminal. An arbitrator may control the HDX aperture system to operate in RX mode for 80 ms per cycle, ensuring the terminal can continuously download video content without interruption. During the 10 ms transmit interval, the user terminal may send periodic feedback to the server, such as, but not limited to, confirmation of packet receipt, requests for stream quality adjustment, or user interaction signals. The final 10 ms of the cycle can be used for guard intervals 250 and switching between modes to avoid collisions or synchronization errors.

The arrangement of timing diagram 200B may be useful for particular data types, such as video streaming or video downloading. For example, by allocating 80% to RX mode, throughput in an embodiment may be 96 Mbps for RX. In contrast, if a conventional FDX array was used, despite needing more RX bandwidth than TX bandwidth, the RX bandwidth would remain fixed at 60 Mbps.

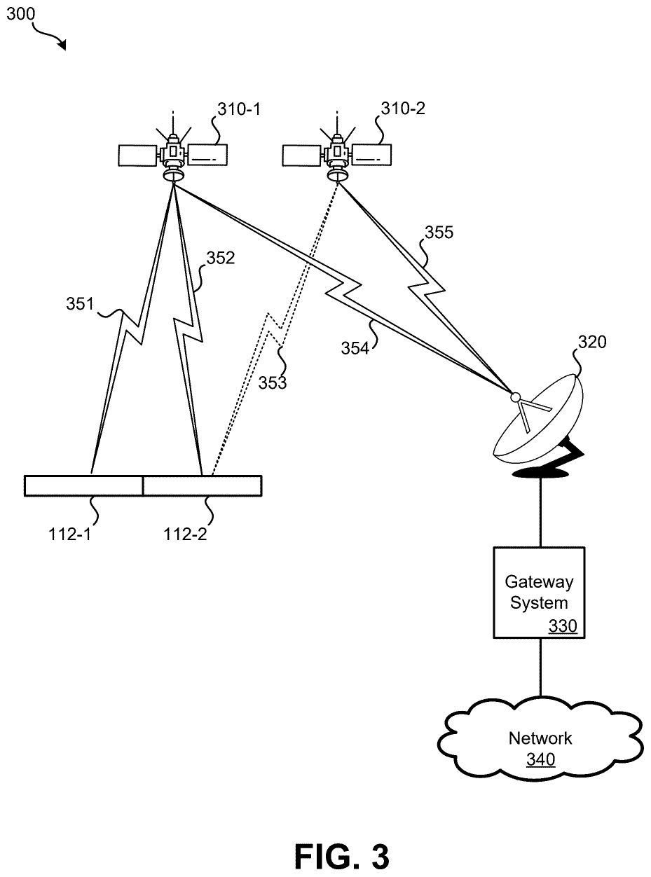

FIG. 3 illustrates an embodiment of a satellite communication system 300 that uses multi-HDX arrays. By way of a non-limiting example, the first HDX array 112-1 and the second HDX array 112-2 may communicate with a first satellite 310-1 during a first time interval. For example, HDX array 112-1 may be in a TX mode for a first signal 351 while HDX array 112-2 may be in a RX mode for a second signal 352.

Satellites 310 used to communicate with the user terminal 100 may include any suitable satellite capable of relaying appropriate signals. For example, types of satellites may include, without limitation, geostationary Earth orbit (GEO) satellites, which remain fixed relative to a point on the Earth's surface at approximately 35,786 kilometers altitude; medium Earth orbit (MEO) satellites, which operate at intermediate altitudes typically between 2,000 and 20,000 kilometers; and low Earth orbit (LEO) satellites, which orbit at altitudes ranging from about 160 to 2,000 kilometers and complete multiple revolutions around the Earth each day. Each type of satellite may provide distinct advantages: GEO satellites can offer wide, continuous coverage ideal for broadcast and backhaul; MEO satellites may balance coverage area and latency; and LEO satellites can provide low-latency, high-throughput links with potential global coverage. The satellite communication system 300 may utilize single satellites or, where suitable, constellations of satellites which are coordinated groups of multiple satellites distributed in specific orbital planes and patterns to provide seamless, overlapping coverage for the HDX arrays 112. Satellite constellations may be organized as non-geostationary networks (e.g., LEO or MEO constellations) to enable continuous, uninterrupted connectivity by handing off the user terminal between satellites 310 as they move across the sky from the point of view of the HDX arrays 112.

In examples where the HDX arrays 112 are implemented as phased arrays, the phased arrays may include multiple radiating elements whose relative phase and amplitude can be dynamically adjusted to electronically steer respective beams without mechanical movement. This allows user terminal 100 to track and maintain optimal alignment with moving LEO or MEO satellites, or to switch beams between satellites during handoff procedures (or GEO during calibration and alignment). The phased array can support single or multiple beams, adaptive nulling for interference mitigation, and retargeting to accommodate the dynamic geometry of satellite constellations.

By way of a non-limiting example, HDX array 112-1 may establish a wireless link with an orbiting satellite 310-1 (e.g., in GEO) serving as a relay node for gateway system 330 or other suitable network infrastructure. HDX array 112-1 may operate in a TX mode while HDX array 112-2 operates in a RX mode, exchanging data and control signals with the currently associated satellite. As satellite 310-1 traverses its orbital path and approaches the edge of the terminal's coverage zone or, based on operation parameters, it is determined that a different satellite would be optimal for transmitting signals to HDX array 112-2 (e.g., operating in the RX mode), a handoff process may be initiated while maintaining continuous connectivity. During the handoff, HDX array 112-2 may coordinate with the arbitrator 140 (or some other component) to terminate communication with satellite 310-1 and establish a new link with incoming satellite 310-2 entering the coverage area to receive signals 353. This process may include, without limitation, monitoring signal quality metrics, receiving handoff commands from the network, and/or executing timing-controlled switching of HDX arrays 112 to synchronize with the new satellite's transmission schedule. Each satellite may operate as a relay, forwarding traffic between user terminal 100 and gateway 330, thereby extending a reach of network 340 (by way of gateway system 330) and supporting seamless communication across a constellation of satellites. The handoff mechanism ensures uninterrupted service by dynamically reassigning HDX array 112-2 as satellites move in and out of view, or more optimum TX/RX modes become available, optimizing network reliability and resource utilization in satellite-based communication systems.

Gateway system 330, along with satellite antenna 320, may be in a communication system that serves as a terrestrial node equipped with antennas (e.g., phased arrays, parabolic reflectors, or suitable equivalents) and associated transceiver hardware for establishing wireless links with satellites. Gateway system 330 can function as an interface between satellites 310 and network 340 (e.g., the Internet). Gateway system 330 may include signal processing equipment, protocol converters, network routers, modems, firewalls, and management software, facilitating the aggregation, routing, and conversion of data streams received from or transmitted to the ground station. Gateway system 330 is further coupled to one or more networks that transmit desired communications to their ultimate destinations. These networks can include public or private Internet infrastructure, cellular networks (e.g., 4G LTE, 5G NR, or suitable equivalents), enterprise wide-area networks (WANs), metropolitan area networks (MANs), local area networks (LANs), fiber optic backbones, cloud-based data centers, broadcast networks, or specialized government, or emergency responder networks.

In operation, satellite antenna 320 receives signals from satellites 310 and/or remote endpoints, forwards these signals to gateway system 330 for processing, and then transmits the processed data through the network (e.g., to and from satellites 310). Additionally, gateway system 330 can receive data from network 340, format and encapsulate it as necessary, and route it through ground station 320 for uplink transmission to satellites 310 or remote receivers. For example, ground station 320 coupled to satellite 310 may relay Internet traffic, via signals 355 and/or signals 354, from a cloud data center to, for example, a fleet of remote IoT sensors, facilitate voice and video calls between mobile devices via cellular and satellite backhaul, support secure government communications by linking to a dedicated defense network, or enable broadcast television distribution by interfacing with terrestrial fiber or microwave links.

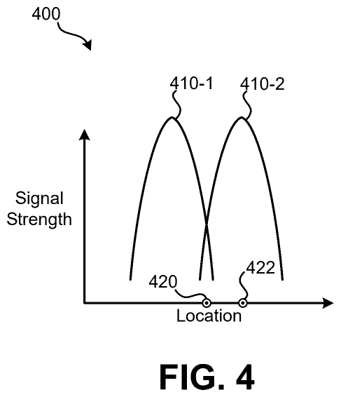

FIG. 4 illustrates an embodiment of a signal strength diagram 400 in which a user terminal that includes a multi-HDX arrays is located between spot beams. (Notably, not all satellite systems utilize spot beams. For example, spot beams may be used by geosynchronous satellite to target particular geographic regions.) Such spot beams may each service earth-fixed cells such that the position of the cells (and thus the boundaries of the cells) do not change in relation to movement of the satellites. By way of a non-limiting example, two beams are depicted. A first spot beam 410-1 (e.g., beam-k) and a second spot beam 410-2 (e.g., beam-k+1) are created by a satellite. While two beams are depicted for ease of discussion, any suitable number of beams e.g., k=1, 2, 3, . . . , etc. and any suitable number of satellites n=1, 2, 3, etc. capable of being in communication with the HDX arrays 112. Spot beam 410-1 may be centered at a first geographic location and spot beam 410-2 can be centered at a second geographic location. By virtue of location 420, at which a user terminal is located, being between these geographic locations, the signal strength of either of beams 410-1 and 420-2 is lower at location 420 than compared to a location corresponding to a center of a spot beam, such as location 422.

In this example, the user terminal located at location 420 is where the coverage areas of adjacent spot beams partially overlap. Signal strength is plotted as a function of geographic position, showing a gradual decrease in signal power as a user terminal moves away from a center of spot beam 410-1 and a corresponding increase as it approaches the center of the second spot beam 410-2. The use of multiple HDX arrays within the user terminal 100 enables continuous communication of signals of different beams or frequency channels (e.g., multiplexing), allowing a user terminal to identify the optimal beam for communication at any given location.

In some examples, user terminal 100 may experience periods of downtime or reduced data throughput, such as when the signal quality degrades due to atmospheric conditions, satellite movement, and/or congestion on a particular frequency channel. If a bandwidth available to first HDX array 112-1 drops below a threshold needed for reliable communication (e.g., no video stuttering), arbitrator 140 may initiate a handoff process to second HDX array 112-2. The handoff process, managed by arbitrator 140, may monitor link metrics and coordinate the transition of communication from first HDX array 112-1 to second HDX array 112-2. During the handoff, user terminal 100 may temporarily suspend data transmission (downtime) to synchronize frequency channels, re-establish timing, and/or perform authentication with the satellite 420. Once second HDX array 112-2 is activated and a stable link is established on a different frequency channel or with a different antenna configuration (e.g., RX mode or TX mode), communication may resume, improving bandwidth and quality of service.

User terminal 100, in some embodiments, can improve its communication performance by using first HDX array 112-1 to communicate with spot beam 410-1 and second HDX array 112-2 to communicate with spot beam 410-2. Spot beams 410 can be created by the same satellite or different satellites. In a non-limiting example, user terminal 100 may simultaneously point to (e.g., via phased arrays of HDX arrays 112) and establish communication links with two distinct satellites (not depicted). User terminal 100 can aggregate available bandwidth of both satellite links to improve (e.g., approximately double) an overall communication throughput in a given direction relative to what could be achieved with a single satellite link. Aggregation may be managed by arbitrator 140, which coordinates the allocation of data streams across both links, balances load, and optimizes resource utilization.

FIG. 5 illustrates an embodiment of a system 500 that includes multiple HDX aperture arrays operating in a full duplex emulation mode. System 500 may emulate a FDX array by using two HDX arrays with one array operating in a 100% TX mode and a second array operating in a 100% RX mode. Switching between control circuitry 510 and RF front ends 120 can be performed such that HDX array 112-1 is used exclusively for RX and HDX array 112-2 is used exclusively for TX. That is, data to be transmitted from modem 530-1 can be routed by control circuitry 510-1 to RF front end 120-2. Such a transition may be performed using electronic or physical switches. Alternatively, data to be transmitted may only be routed to modem 530-2 by arbitrator 540.

By way of a non-limiting example, system 500 may be in communication with a satellite receiving signals on first HDX array 112-1 and second HDX array 112-2. In an instance where second HDX array 112-2 fails for unexpected reasons (e.g., power surge on an unprotected component), arbitrator 540 (which may be integrated in modem 530-1 or may be separate as detailed in relation to FIG. 3) may control switching of control circuitry 510-1 to coordinate TX/RX modes of HDX array 112-1 (e.g., utilizing timing as described with respect to FIG. 2). Similarly, if HDX array 112-1 fails or is disrupted for various reasons, arbitrator 540 may control circuitry 510-1 or control circuitry 520-2 to utilize the HDX array 112-2 for TX/RX modes. Each of the components, with the exception of the IDU 150, can be a component of an outdoor unit (ODU).

Switching between HDX array 112-1 and HDX array 112-2 may be performed for a variety of technical and operational reasons, each intended to optimize (or increase) data throughput, user terminal 100 performance, reliability, or adaptability. Such switching may be initiated in response to degraded signal quality, nonfunctioning equipment, reduced link margin, and/or adverse atmospheric conditions, including but not limited to rain, fog, snow, dust, or other environmental attenuation affecting the received signal. Switching between HDX array 112-1 and HDX array 112-2 may also be triggered by the presence of detected faults, physical obstructions, shadowing, or multipath interference resulting from terrain features, buildings, or moving objects. In certain embodiments, switching may occur to enable frequency agility, such as selecting an array configured for a different frequency band to avoid interference, comply with regulatory restrictions, and/or respond to dynamic spectrum allocation. Arbitrator 140 may further switch arrays to maintain connectivity as user terminal 100 transitions between coverage zones, for example, moving from one satellite spot beam, cellular sector, or wireless access point to another. Redundancy and fault tolerance may necessitate activation of a backup array upon detection of hardware failure (as described above), signal path degradation, or scheduled maintenance of the primary array. Load balancing and throughput optimization may prompt the system to utilize alternative arrays when congestion or bandwidth limitations are encountered, thereby improving aggregate capacity. In mobile or dynamic implementations of user terminal 100 (e.g., vehicles), switching may be employed to maintain optimal elevation angles or line-of-sight with satellites or aerial platforms. Environmental changes, including, without limitation, temperature variations, vibration, or mechanical stress, may further motivate array selection to preserve stable operation. Additionally, switching may be executed in accordance with protocol restrictions, handoff procedures, and/or network commands to enhance resource utilization, facilitate multi-user access, support security objectives, or enable service continuity during scheduled or unscheduled system upgrades or reconfiguration.

It is possible that an HDX array or the hardware connected with it could fail during operation. If so, via control circuitry 510, signals can be rerouted such that only HDX array 112-1 is used for both RX and TX. Further, via control circuitry 510, signals can be rerouted such that only HDX array 112-2 is used for both RX and TX if HDX array 112-1 or its associated hardware fails.

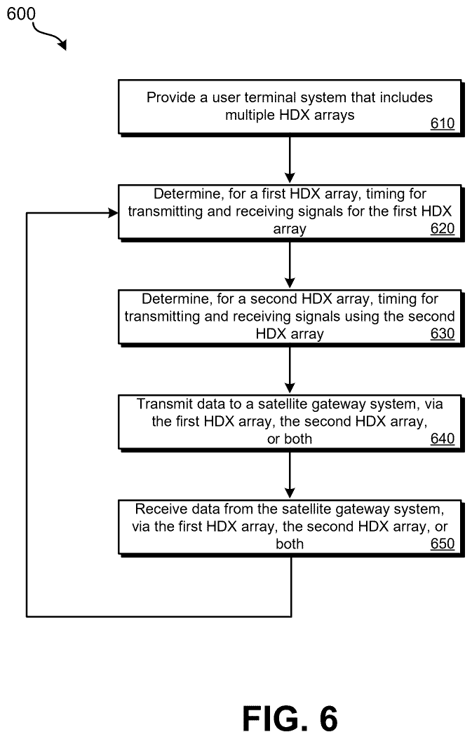

Various methods may be performed using the systems and arrangements detail in relation to FIGS. 1-5. FIG. 6 illustrates an embodiment of a method for using a user terminal that includes multiple HDX aperture arrays. Embodiments of method 600 can be performed in context of an IDU, ODU, and/or user terminal, such as described herein in relation to FIGS. 1-5. As described herein, the IDU, ODU, and/or user terminal are configured to control the TX and RX configuration of multiple HDX arrays based on various parameters. As such, it is possible to increase and/or optimize data throughput using a time-based assignment of RX and TX modes of each HDX array. The TX and RX modes can dynamically be assigned based on the type of data being transmitted, satellite coverage, and/or optimum bandwidth pathing.

At block 610, a user terminal system can be provided that includes multiple HDX arrays. For example, the user terminal (e.g., user terminal 100) system may include a first HDX aperture system having a first aperture and a second HDX aperture system having a second aperture distinct from the first aperture.

At block 620, for a first HDX array (e.g., HDX array 112-1), timing for transmitting (e.g., TX mode 210-1) and receiving signals (e.g., RX mode 230-1) for the first HDX array can be determined. This determination can be performed by an arbitrator (e.g., arbitrator 140) or by some other computerized component of a user terminal. As detailed in relation to FIGS. 2A and 2B, a percentage of time may be allotted for transmission (TX), a different percentage of time for reception (RX), and the remaining percentage of time for guard bands of time between transmitting and receiving. It is also possible for one of the HDX systems to be 100% allocated to TX or RX, while the other HDX system is allocated some non-zero percentage to both TX and RX.

At block 630, for a second HDX array (e.g., HDX array 112-2), timing for transmitting and receiving signals using the second HDX array can be determined. Similar to block 620, this determination can be performed by an arbitrator (e.g., arbitrator 140) or by some other computerized component of a user terminal. Gain here, as detailed in relation to FIGS. 2A and 2B, a percentage of time may be allotted for transmission (TX), a different percentage of time for reception (RX), and the remaining percentage of time for guard bands of time between transmitting and receiving. The percentages assigned at block 630 can be the same as those assigned at block 620 or can differ.

The percentages of blocks 620 and 630 can be selected based on the type of data being transmitted and/or received by the UT. Possibly based on deep packet inspection (DPI), a determination can be made on the type of data being transmitted or received. For example, if the UT is receiving video (e.g., streaming a movie), a much larger portion of time may be allotted to RX. If the UT is uploading a file, a much larger portion of time may be allotted to TX. Common possible types of data include: video conferencing, audio streaming, video streaming, file uploads, general web browsing, and email.

At block 640, data is transmitted to a satellite gateway system (e.g., gateway system 330), via the first HDX array, the second HDX array, or both in accordance with blocks 620 and 630. The data transmitted via the two HDX arrays may be transmitted to a single satellite or to different satellites. If different satellites, the satellites may be part of the same or separate constellations. For example, the first satellite may be in low earth orbit and the second satellite is in geosynchronous orbit.

At block 650, the two HDX arrays can be used to receive data from one or more satellites in accordance with blocks 620 and 630. Again here, the data received via the two HDX arrays may be received from a single satellite or from different satellites. If different satellites, the satellites may be part of the same or separate constellations. In some embodiments, different carrier frequencies may be used by the HDX arrays, with each carrier being for the same or different satellites.

Following block 650, a periodic or occasional reanalysis may be performed to dynamically reassign the amount of time each HDX array is used for transmission and reception. As the type of data received and/or transmitted changes, the allocation between RX and TX can be updated to improve performance, especially over what would be possible with a FDX aperture array.

It is also possible to transition into (and out of) a full duplex emulation mode. Blocks 620 and 630 can involve determining that a full duplex mode should be entered. The user terminal system may be set to a full duplex emulation mode in which the first half duplex aperture system is used exclusively to transmit data (e.g., TX mode) and the second half duplex aperture system is used exclusively to receive data (e.g., RX mode). This full duplex mode may be set based on user input or information received from gateway system 330. For example, a service provider operating the satellite communication system or an end user of the user terminal may set the user terminal to the full duplex mode. Similarly, one of these parties may cause the user terminal to exit the full duplex mode and resume dynamic assignment of RX and TX for each of the HDX arrays.

In other embodiments, more than two HDX arrays can be used. For example, similar methods can be applied to user terminals that use three, four, or more HDX arrays. With the addition of more HDX arrays and associated hardware, performance can be further improved.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the scope of the claims.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the scope of the claims. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A user terminal system, comprising:
a first half duplex (HDX) aperture system comprising a first aperture; and
a second half duplex aperture system, comprises a second aperture distinct from the first aperture;
one or more modems in communication with the first half duplex aperture system and the second half duplex aperture system; and
an arbitrator in communication with the one or more modems, wherein
a first amount of time is allocated to data transmission for the first half duplex aperture system and a second amount of time is allocated to data transmission for the second half duplex aperture system.

2. The user terminal system of claim 1, wherein the first aperture and the second aperture are distinct portions of one antenna array.

3. The user terminal system of claim 1, wherein the first half duplex aperture system communicates with a different satellite beam than the second half duplex aperture system.

4. The user terminal system of claim 1, wherein the first half duplex aperture system is configured to communicate with a first satellite while the second half duplex aperture system communicates with a second satellite.

5. The user terminal system of claim 4, wherein the first satellite is in low earth orbit and the second satellite is in geosynchronous orbit.

6. The user terminal system of claim 1, wherein the first amount of time is different than the second amount of time.

7. The user terminal system of claim 1, wherein the user terminal system is configured to be set to a full duplex emulation mode in which the first half duplex aperture system is used exclusively to transmit data and the second half duplex aperture system is used exclusively to receive data.

8. The user terminal system of claim 1, wherein the arbitrator is configured to communicate with an indoor unit and is configured to route communications between the indoor unit, a first modem of the one or more modems, and a second modem of the one or more modems.

9. The user terminal system of claim 1, wherein the user terminal system is configured such that in response to the second half duplex aperture system becoming unavailable, the first amount of time allocated to data transmission for the first half duplex aperture system is modified.

10. The user terminal system of claim 1, further comprising:
a satellite gateway system, and
a satellite configured to communicate with the satellite gateway system, wherein the one or more modems communicate with the Internet via the satellite gateway system.

11. A method for using multiple half duplex (HDX) aperture arrays, the method comprising:
providing a user terminal system that includes a first HDX aperture system and a second HDX aperture system;
determining, by the user terminal system, a first timing for transmitting and receiving signals for the first HDX aperture system;
determining, by the user terminal system, a second timing for transmitting and receiving signals for the second HDX aperture system;
transmitting data to a satellite gateway system via the first HDX aperture system, the second HDX aperture system, or both, in accordance with the determined first and second timings; and
receiving data from the satellite gateway system via the first HDX aperture system, the second HDX aperture system, or both, in accordance with the determined first timing and the determined second timing.

12. The method of claim 11, wherein the first HDX aperture system comprises a first aperture and the second HDX aperture system comprises a second aperture, and wherein the first aperture and the second aperture are distinct portions of one antenna array.

13. The method of claim 11, further comprising: communicating, by the first HDX aperture system, with a different satellite beam than the second HDX aperture system.

14. The method of claim 11, further comprising: communicating, by the first HDX aperture system, with a first satellite while the second HDX aperture system communicates with a second satellite.

15. The method of claim 14, wherein the first satellite is in low earth orbit and the second satellite is in geosynchronous orbit.

16. The method of claim 11, wherein the first timing allocates a different amount of time to data transmission than the second timing.

17. The method of claim 11, further comprising operating in a full duplex emulation mode, wherein determining the first timing comprises allocating all available time for the first HDX aperture system to transmitting data, and wherein determining the second timing comprises allocating all available time for the second HDX aperture system to receiving data.

18. The method of claim 11, wherein an arbitrator performs the determining of the first timing and the second timing.

19. The method of claim 11, further comprising:
detecting that the second HDX aperture system has become unavailable; and
in response, modifying the first timing for the first HDX aperture system.

20. The method of claim 11, wherein transmitting data to the satellite gateway system and receiving data from the satellite gateway system occurs via a satellite in communication with a satellite gateway antenna coupled to the satellite gateway system, thereby enabling communication with the Internet.
